(19) United States
(12) Patent Application Publication
(10) Pub. No.: US 2026/0097904 A1
(43) Pub. Date: Apr. 9, 2026

(54) Vibratory Conveyor Having a Magnetic Drive

(71) Applicant: Key Technology, Inc., Walla Walla, WA (US)

(72) Inventors: Eugene Groenewald, Woerden (NL); Raimon Corné Johan Smit, Schalkwijk (NL)

(21) Appl. No.: 18/910,991

(22) Filed: Oct. 9, 2024

(51) Int. Cl. B65G 27/24; B65G 27/08

(52) U.S. Cl. CPC B65G 27/24; B65G 27/08; B65G 2812/0308; B65G 2812/0364

(57) ABSTRACT

A excited frame conveyor includes a reciprocally moveable elongated conveyor bed, having a product conveying surface, and a stationary base which supports the elongated conveyor bed spacedly adjacent the stationary base on a plurality of elongated resilient spring legs, and the stationary base has a magnetic drive which is oriented in spaced relation relative to the conveyor bed and which, when selectively energized and selectively deenergized, imparts reciprocal motion to the elongated conveyor bed to move the product along the product conveying surface of the elongated conveyor bed.

### TECHNICAL FIELD

The present invention relates to a conveyor assembly for transporting a stream of products along a conveying surface, and more specifically to a vibratory conveyor assembly which employs a magnetic force drive assembly which imparts a desirable reciprocal motion to a conveyor bed so as to transport a product therealong.

### BACKGROUND OF THE INVENTION

Vibratory conveyors, of various designs are well known. These devices have been employed in assorted industry segments for decades. One particular form of vibratory conveyor, that being, the excited frame vibratory conveyor, has found widespread usage in food processing and other industries, Excited frame conveyor construction, and its operation are well known. In most forms of the invention, a stationary base frame which rests upon, or is suspended from, a supporting surface, mounts one, or more, out-of-balance electric motors, which rotate an eccentric weight in order to impart a vibratory force, which is directed along a given line of reference (also known as a work plane) passing through the center of mass of the vibratory conveyor bed. The generated force causes the vibratory conveyor bed to reciprocate in a given direction at a predetermined frequency by means of a multiplicity of leaf springs, which moveably support the conveyor bed on the base frame.

The aforementioned excited frame vibratory conveyors are extremely reliable and are convenient to use. Notwithstanding the high reliability of such excited frame conveyors, shortcomings in the operation of such devices have been the attention of designers, and the users of such devices, for many years. For example, designers of such excited frame conveyors have known, for some period of time, that as the length of the conveyor bed increases, certain resonant vibratory frequencies are generated as the conveyor bed begins to reciprocate following the energizing of these aforementioned, out-of-balance motors and eccentric weights. These resonant vibratory frequencies (residence modes), under certain conditions, can cause undesirable motion in the conveyor bed. These resonant frequencies become an increasing problem as the conveyor bed becomes longer. Solutions to avoid these resonance modes employing the aforementioned out-of-balance motors and eccentric weights have entailed utilizing various schemes and methodologies to energize the out-of-balance motors in a predetermined manner so as to prevent these resonance modes from causing adverse side-to-side or twisting motions, or yawing, of the conveyor bed, about its longitudinal axis. These schemes and methodologies have included so-called “ramp up” or “ramp down” energizing of the respective out-of-balance motors in specific sequences so as to minimize the resonance modes that are generated. Still further, the generation of these resonance modes, which causes adverse movement of the conveyor bed, especially at longer lengths, has caused another problem to arise, that being, the premature wear, or breakage of the leaf springs which resiliently support the conveyor bed spacedly adjacent the base frame.

In addition to the foregoing shortcomings, the use of out-of-balance motors employing eccentric weights has long known problems which are associated with the premature wear of bearings, which support the rotating shafts of the electric motors bearing the eccentric weights. As should be understood, from time-to-time such out-of-balance motors need to be replaced due to excessive bearing wear.

In addition to the foregoing, excited frame conveyors when rendered operable, utilize given eccentric weights, which provides a predetermined frequency of vibration for the accompanying conveyor bed. As should be understood, depending upon the weight of the product being transported by the conveyor bed, adjustment of the vibratory force, which is imparted to the conveyor bed, is difficult to change, absent replacement of the eccentric weights, which are rotated by the out-of-balance motors. Changing these weights takes some period of time to accomplish, Therefore, there is currently no convenient means to make both a frequency and amplitude change of the amount of force that an out-of-balance motor provides to a conveyor bed, absent significant revisions to the drive arrangement of such prior art excited frame conveyors. Further still, for extremely long conveyors, and which may have multiple motors at given locations along the length of the conveyor bed, such conveyors employ a rather complex control system to control these multiple spacedly arrayed motors. Finally, the use of out-of-balance motors limits the designer to the use of a system, which employs merely a vibratory force, which is most accurately depicted as a sine-wave. Use of out of balance motors does not allow a designer to employ vibratory force, which may best be understood as being a complex wave form. Such a complex vibratory wave form may be useful for moving specific particulate matter along a given conveyor bed.

Other designs of drive assemblies have been fabricated to avoid the aforementioned problems and shortcomings. For example the present inventor has conceived the present novel drive assembly employing an electromagnetic which is effective when selectively energized and selectively deenergized to impart reciprocal motion to a conveyor bed that can be understood as a complex sine wave form. The Office's attention is directed to the teachings as found in U.S. Pat. No. 9,132,966 the teachings of which are incorporated by reference herein.

The present invention, as described hereinafter, avoids the detriments associated with the prior art practices utilized heretofore, and provides a new vibratory conveyor assembly for moving particulate product along a conveyor bed, in a particularly noteworthy manner.

### SUMMARY OF THE INVENTION

A first aspect of the present invention relates to a vibratory conveyor which includes an elongated, reciprocally moveable conveyor bed having a product conveying surface; a stationary base for supporting the elongated conveyor bed; a multiplicity of elongated springs communicating between the elongated conveyor bed and the stationary base to support the elongated conveyor bed in reciprocally movable relation relative to the stationary base; and a magnetic drive which is carried by the stationary base and which is oriented in spaced relation relative to the elongated conveyor bed, and which, when selectively energized and selectively deenergized, imparts reciprocal motion to the elongated conveyor bed so as to move a product along the product conveying surface of the elongated conveyor bed.

A still further aspect of the present invention relates to a vibratory conveyor which includes an elongated reciprocally moveable conveyor bed having a product conveying surface, and which further has a center of mass, and a given weight; a stationary base supported by a supporting surface, and wherein the stationary base supports the elongated reciprocally moveable conveyor bed in a predetermined, spaced relationship relative to the base, and wherein the stationary base has a given weight; a plurality of elongated springs which resiliently couple the elongated reciprocally moveable conveyor bed to the stationary base, and further locates the elongated reciprocally moveable conveyor bed in spaced relation relative to the stationary base; a magnetic drive assembly carried by the stationary base which, when selectively energized and selectively deenergized generates a periodic, reciprocal physical force that imparts reciprocal motion to the elongated moveable conveyor bed so as to effect a movement of a product along the product conveying surface; a controller electrically coupled to the drive assembly, and which directs impulses of electrical energy to the drive assembly, and wherein the drive assembly produces magnetic attraction forces at a predetermined frequency, which in turn generate a reciprocating vibratory force which is imparted to the elongated reciprocally moveable conveyor bed so as to cause movement of the product along the product conveying surface and along a path of travel.

A further aspect of the present invention is a vibratory conveyor, comprising an elongated, reciprocally movable conveyor bed for carrying a product along a path of travel, and wherein the elongated reciprocally movable conveyor bed has a center of mass; a base for supporting the elongated reciprocally movable conveyor bed relative to a supporting surface; a multiplicity of spacedly arrayed elongated springs extending from the base, and supporting the reciprocally movable conveyor bed in spaced, reciprocally movable relation relative to the base; and a drive assembly mounted on the base, the drive assembly having a predetermined weight and a center of mass, an attractor plate and a selectively energizable electromagnet that is spaced apart from the attractor plate, and wherein the selective energizing and selective de-energizing of the electromagnet effects a reciprocal motion of the attractor plate relative to the selectively energizable electromagnet so as to create a reciprocating force which extends along a predetermined line of reference/work plane which passes through the center of mass of the elongated reciprocally movable elongated conveyor bed, and passing through the center of mass of the drive assembly, which affects the movement of the product along the path of travel of the conveyor bed.

A further aspect of the present invention is a vibratory conveyor, having one electromagnet, and one attractor plate.

A further aspect of the present invention is a vibratory conveyor, comprising a base having opposite first and second ends, and opposite sides which are spaced apart a predetermined distance, and wherein a medial channel is defined between the opposite sides; an elongated conveyor bed which is moveably mounted on, and disposed in spaced relation relative to the base, and wherein the elongated conveyor bed has opposite first and second ends, and a center of mass, and wherein the elongated conveyor bed has a supporting surface which carries a product which is movable between the first and second ends thereof when the elongated conveyor bed is reciprocally moved in a predetermined manner; a first multiplicity of elongated resilient spring legs, each of the first multiplicity of elongated resilient spring legs having a first end which is mounted on the base, and a second end which is mounted on the elongated conveyor bed, and the first multiplicity of elongated resilient spring legs are positioned at a predetermined angle relative to both the base and the elongated conveyor bed, and the first multiplicity of elongated resilient spring legs reciprocally support the elongated conveyor bed spacedly adjacent to the base so as to effect movement of the product along the supporting surface of the conveyor bed; and a drive assembly borne by the base, and located within the medial channel defined by the base, and wherein the drive assembly includes a drive saddle which defines a magnet seat, and wherein the magnet seat is at a predetermined angular orientation, relative to the base, and wherein an electromagnet is adjustably carried on the magnet seat, and the drive saddle further includes a multiplicity of spacedly arrayed spring mounts located in a predetermined spacedly arrayed pattern; and a second multiplicity of spring arms and each of the second multiplicity of spring arms has a first end mounted on one of the multiplicity of spacedly arrayed spring mounts of the drive saddle, so as to extend outwardly therefrom at a predetermined angle, and wherein each of the respective second multiplicity of spring arms has a distal second end spaced apart from the drive saddle; and a weight holder interconnected at the second ends of each of the second multiplicity of spring arms in a predetermined, spaced relationship relative to the drive saddle, and wherein the weight holder carries an attractor plate in a given angular, and spaced orientation relative to the electromagnet carried by the drive saddle, and wherein the weight holder, and the attractor plate carried thereby have a total given mass, and the total given mass is reciprocally moveable along a line of force/work plane which extends substantially through a center of mass of the drive assembly and substantially through the center of mass of the elongated conveyor bed; and wherein selective energizing and selective de-energizing of the electromagnet sequentially draws toward, and releases the attractor plate to/from the energized/deenergized electromagnet which responsively generates a reciprocal motion of the weight holder, and wherein the reciprocal motion generates a force along the line of force/work plane which effects a corresponding reciprocal motion of the elongated conveyor bed, and a responsive movement of the product along the supporting surface thereof.

A further aspect of the present invention is a vibratory conveyor wherein the electromagnetic has a generally planar interaction surface; and the attractor plate has a generally planar interaction surface; and both the generally planar interaction surfaces are oriented parallel to one another and angular relative to the second multiplicity of spring arms.

A further aspect of the present invention is a vibratory conveyor wherein the electromagnetic has a generally planar interaction surface; and the attractor plate has a generally planar interaction surface; and both the generally planar interaction surfaces are oriented generally horizontally and parallel to a product conveying surface of the elongated conveyor bed.

A further aspect of the present invention is a vibratory conveyor wherein selective activation of the electromagnet generates a magnetic field which responsively draws the attractor plate, and the weight holder, in a first direction of movement and into closer proximity to the energized electromagnet; and selective deactivation of the electromagnet allows the second multiplicity of spring arms to bias the weight holder and the attractor plate into a second direction of movement, and the second direction of movement is opposite the first direction of movement.

A further aspect of the present invention is a vibratory conveyor wherein an angle between the second multiplicity of spring arms that support the weight holder and attractor plate in spaced relation relative to the drive saddle, and a line extending parallel to a generally planar interaction surface of the electromagnet is between approximately 10° and 70°.

A further aspect of the present invention is a vibratory conveyor wherein an angle between the second multiplicity of spring arms that support the weight holder and attractor plate in spaced relation relative to the drive saddle, and a line extending parallel to a generally planar interaction surface of the electromagnet is preferably between approximately 15° and 45°.

A further aspect of the present invention is a vibratory conveyor wherein an angle between the second multiplicity of spring arms that support the weight holder and attractor plate in spaced relation relative to the drive saddle, and a line extending parallel to a generally planar interaction surface of the electromagnet is 22.5°.

A further aspect of the present invention is a vibratory conveyor wherein the magnet seat defines a plurality of spacedly arrayed holes for receiving individual mounting posts which adjustably position and carry the electromagnet.

A further aspect of the present invention is a vibratory conveyor wherein each of the second multiplicity of spring arms are mounted upon, and communicate between the weight holder spring arm mount, and the drive saddle spring arm mount to support the weight holder in a predetermined spaced orientation relative to the drive saddle.

A further aspect of the present invention is a vibratory conveyor wherein the selectively energizable electromagnet, when rendered operable, magnetically draws the attractor plate into closer proximity to the energized electromagnet which responsively deflects/biases each of the second multiplicity of spring arms in a first direction resulting in an accumulation of potential energy in each of the deflected second multiplicity of spring arms.

A further aspect of the present invention is a vibratory conveyor wherein the magnetic attraction of the attractor plate to the selectively energizable electromagnet effects movement of the weight holder in a first direction towards the electromagnet responsive to the electromagnet to receiving the electrical power from the controller; and biasing return movement of the weight holder in a second direction is caused by selective deactivation of the electromagnet and release of stored potential energy from the second multiplicity of spring arms which generate movement of the weight holder along the predetermined line of reference/work plane in a second direction.

A further aspect of the present invention is a vibratory conveyor wherein a magnetic field generated by the selectively activated electromagnet may be periodically activated and deactivated by the controller so as to cause the weight holder to reciprocally move relative to the drive saddle at a desired frequency, and amplitude, along a line of reference/work plane that passes through a center of mass of the drive assembly.

A further aspect of the present invention is a vibratory conveyor wherein a frequency and an amplitude of the movement of the weight holder may be altered by the controller.

A further aspect of the present invention is a vibratory conveyor wherein the generated reciprocal force, and the resulting reciprocal motion of the elongated conveyor bed effects movement of product along the product transporting surface of the elongated conveyor bed, and between the first and second ends of the elongated conveyor bed.

A further aspect of the present invention is a vibratory conveyor, comprising a base having a first side, and a spaced apart, and parallel, second side, and wherein the first and second sides each have a first end, a second end, a top edge and a bottom edge, and wherein an end panel communicates between the first side, and the second sides at one end thereof, and wherein the base further defines a medial channel which is located between the first and second sides; a drive assembly which is borne by the base, and is further carried within the medial channel, and wherein the drive assembly comprises a drive saddle, a weight holder, and a selectively energizable electromagnet, and wherein the drive saddle has a first side, and a parallel, spaced apart, second side, and wherein each side has a first end, and a second end, and wherein each side further has a laterally outwardly facing surface, and an opposing, laterally inwardly facing surface, and wherein a crossbeam structurally communicates between the first side, inwardly facing surface, and the second side, inwardly facing surface, and wherein the crossbeam structurally carries a magnet seat between the first side, and the second side, and at a location which is generally medial between the first end and the second end, and wherein the magnet seat further defines a plurality of spaced holes for receiving mounting posts which adjustably position and carry a selectively energizable electromagnet, and wherein the first and the second sides each carry a plurality of spacedly arrayed spring arm mounts on the laterally inwardly facing surfaces, and wherein each of the plurality of spring arm mounts carries an elongated spring arm; and the plurality of elongated spring arms movably support to the weight holder in a spaced orientation relative to the drive saddle; and wherein the weight holder has a first side, and a spaced apart, and parallel, second side, and wherein each of the first and second sides has a first end, and a second end, and wherein a mounting block is carried between the first side, and the second side, and the mounting block carries an attractor plate, and wherein the weight holder first and second sides, each carry a plurality of spacedly arrayed spring arm mounts on a laterally outwardly facing surface thereof, and the individual elongated spring arms are mounted on each of the plurality of spacedly arrayed spring arm mounts carried by the weight holder, and to the plurality of spring arm mounts carried by the drive saddle to support the weight holder in the spaced orientation relative to the drive saddle; and wherein the selectively energizable electromagnet mounted on the magnet seat of drive saddle, when rendered operable, sequentially, and magnetically attracts, the attractor plate which is carried by the weight holder when electrical energy is selectively supplied to the electromagnet by a controller which responsively draws the attractor plate closer to the selectively energizable magnet and correspondingly deflects/biases the multiplicity of spring arms in a first direction; and wherein when the selectively energizable magnet is deenergized, the multiplicity of spring arms return to an unbiased position effectively moving the weight holder in a second direction opposite the first direction, and wherein the movement of the weight holder generates a force along a predetermined line of reference/work plane; an elongated conveyor bed having opposite first and second ends, a top surface defining a product transporting surface which supports a product for movement between the respective opposite ends of the elongated conveyor bed, and a bottom surface, and wherein the elongated conveyor bed is reciprocally and resiliently supported in spaced relation relative to the base, and wherein the elongated conveyor bed has a center of mass through which the predetermined line of reference passes; a multiplicity of elongated resilient spring legs which individually, and resiliently support the elongated conveyor bed in spaced relation relative to the base, and wherein each of the multiplicity of elongated resilient spring legs each have a respective first end which is fixedly attached to the base, and an opposite second end, which is fixedly affixed to the elongated conveyor bed; and a controller which electrically and operationally communicates with a source of electrical power, and wherein the controller selectively supplies electric power to the selectively energizable electromagnet so as to cause the electromagnet to generate a magnetic field, and wherein when the selectively energizable electromagnet is energized by the controller the generated magnetic field draws the attractor plate into closer proximity to the energized selectively energizable electromagnet, thereby causing the weight holder to reciprocally move relative to the drive saddle at a desired frequency, and amplitude, and along the line of reference/work plane, and wherein the frequency of the weight holder movement may be adjusted by the controller, and wherein the reciprocal movement of the weight holder relative to the drive saddle generates a predetermined amount of vibratory force which is imparted to the elongated conveyor bed, so as to effect reciprocal motion of the elongated conveyor bed, and facilitate the movement of the product along the product transporting surface.

A still further aspect of the present invention is a vibratory conveyor further comprising: a second selectively energizable electromagnet carried by the drive saddle; and a second attractor plate carried by the weight holder.

A still further aspect of the present invention is a vibratory conveyor wherein the selectively energizable electromagnet is carried by the weight holder; and the attractor plate is carried by the drive saddle.

An even still further aspect of the present invention is a drive assembly for a vibratory conveyor comprising: a selectively energizable electromagnet; and an attractor plate spaced apart from the selectively energizable electromagnet a predetermined distance; and a plurality of spacedly arrayed elongated springs interconnecting, and communicating between a drive saddle that carries the selectively energizable electromagnet, and a weight holder that carries the attractor plate; and wherein selective energizing of the selectively energizable electromagnet causes the selectively energizable electromagnet to generate a magnetic field which draws the attractor plate, and the weight holder, into a first direction of movement and into closer proximity to the energized selectively energizable electromagnet; and selective deenergizing of the selectively energizable electromagnet allows the plurality of spacedly arrayed elongated springs to bias the attractor plate, and the weight holder, into a second to direction of movement and a distally from the selectively energizable electromagnet, and the second to direction of travel is opposite the first direction of travel; and selectively energizing and deenergizing the selectively energizable magnet generates reciprocal vibration that is communicated to an elongated conveyor.

An even still further aspect of the present invention is a vibratory conveyor, comprising: an elongated, reciprocally movable conveyor bed for carrying a product along a path of travel, and wherein the elongated reciprocally movable conveyor bed has a center of mass; a base for supporting the elongated reciprocally movable conveyor bed relative to a supporting surface; a multiplicity of spacedly arrayed elongated springs extending from the base, and supporting the reciprocally movable conveyor bed in spaced, reciprocally movable relation relative to the base; and a drive assembly carried by the base, the drive assembly having a weight holder that has an attractor plate, a total predetermined weight and a center of mass, and the drive assembly further has a selectively energizable electromagnet that is spaced apart, a predetermined distance, from the attractor plate, and wherein selective energizing and selective de-energizing of the electromagnet effects a reciprocal motion of the weight holder and attractor plate relative to the selectively energizable electromagnet so as to create a reciprocating force which extends along a predetermined line of reference/work plane which passes through the center of mass of the weight holder, and which is parallel to a line passing through the center of mass of the elongated reciprocally movable elongated conveyor bed, which affects the movement of the product along the path of travel of the conveyor bed; and a controller that selectively energizes and selectively de-energizes the selectively energization electromagnet.

These and other aspects of the present invention will be discussed in greater detail hereinafter.

### BRIEF DESCRIPTION OF THE DRAWINGS

Preferred embodiments of the invention are described below with reference to the following accompanying drawings.

FIG. 1 is an isometric top, side elevation view of one form of the vibratory conveyor of the present invention.

FIG. 2 is an isometric bottom view of the vibratory conveyor as seen in FIG. 1.

FIG. 3 is an orthographic side elevation view of the vibratory conveyor as seen in FIG. 1.

FIG. 4 is a top, plan view of the vibratory conveyor, as seen in FIG. 1.

FIG. 5 is an exploded, isometric view of the vibratory conveyor, as seen in FIG. 1.

FIG. 6 is an orthographic, partial cross section, side elevation view of a second embodiment of the vibratory conveyor that is dimensionally longer, having additional pairs of springs, and having two magnets and two attractor plates in the drive assembly.

FIG. 7 is an enlarged orthographic side elevation view of a first embodiment of the magnetic drive assembly which forms a feature of the present invention.

FIG. 8 is an enlarged orthographic side elevation view of a second embodiment of the magnetic drive assembly of the present invention.

FIG. 9 is an enlarged orthographic side elevation view of the magnetic drive assembly, of FIG. 6.

FIG. 10 is an enlarged perspective view of the magnetic drive assembly of FIG. 7.

FIG. 11 is an orthographic side elevation view of an elongated conveyor similar to that of FIG. 6 showing use of two plural magnet drive assemblies of FIG. 9.

### DETAILED DESCRIPTION OF THE PREFERRED EMBODIMENTS

This disclosure of the invention is submitted in furtherance of the Constitutional purposes of the U.S. Patent Law “to promote the progress of science in useful arts” [Article I, Section 8]. As used herein, the term “substantially” means ±10% of the stated amount/measurement.

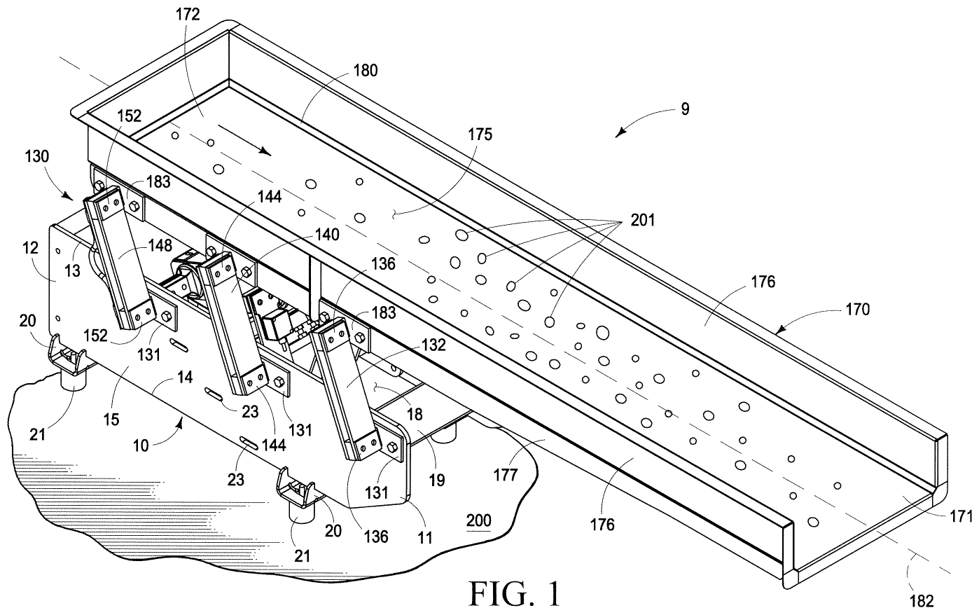

The vibratory conveyor having a magnetic drive assembly of the present invention is generally indicated by the numeral 9 in FIG. 1. The vibratory conveyor 9 comprises a stationary base 10; a drive assembly 30; a support frame 130; a reciprocally movable elongated conveyor bed 170; and a controller 190. The vibratory conveyor 9, as depicted in FIG. 1, rests in spaced relation relative to a supporting surface 200, here illustrated, as an underlying floor. However, it should be understood that the vibratory conveyor 9, as depicted herein, may be suspended from an overhead supporting surface (not shown), such as a ceiling, mezzanine, or the like, in various, industrial applications or environments. Further, it should be understood that although only one drive assembly 30, and a single electromagnet 51 is shown in the accompanying drawings for powering the reciprocally movable elongated conveyor bed 170, it is expressly contemplated that plural drive assemblies 30, having plural similarly oriented electromagnets 51 and associated attractor plates 100 may function to power longer and/or larger reciprocally movable elongated conveyor beds 170.

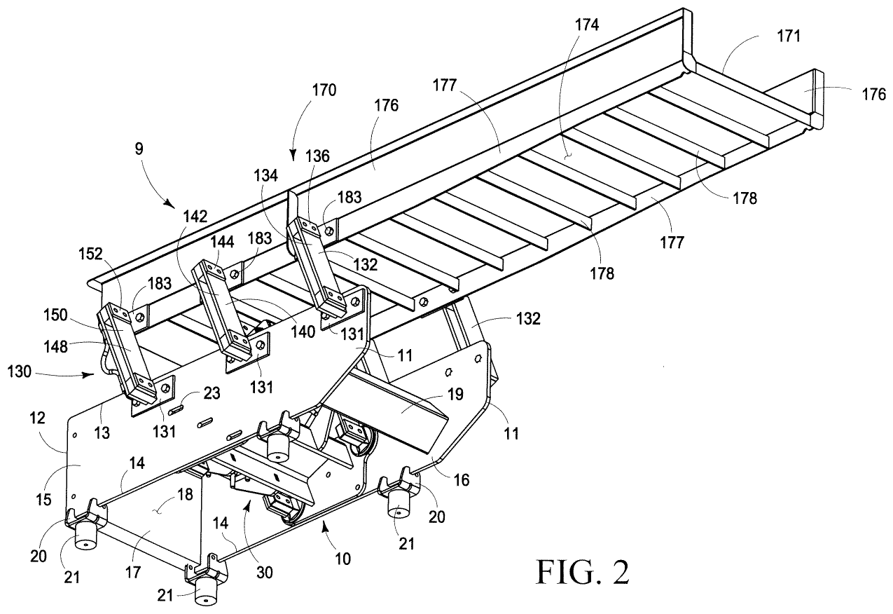

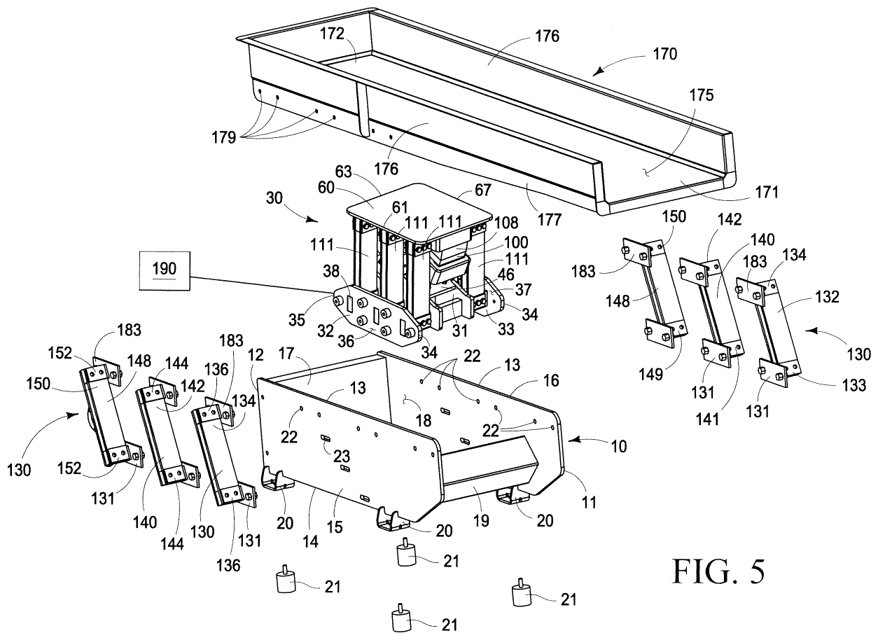

The stationary base 10 (FIG. 2) may be somewhat “U” shaped in configuration, and has a first side panel 15, and a spaced apart, and parallel second side panel 16. Each of the side panels 15, 16 have a first end 11, an opposite second end 12, a top edge 13, a bottom edge of 14, and further defines a plurality of aligned, spacedly arrayed, and elongated holes 23 to adjustably mount the drive assembly 30. An end panel 17 communicates between the first side panel 15, and the second side panel 16, at the second end 12. The end panel 17 causes the first side panel 15, and the second side panel 16 to be spaced apart from one another, and further defines a medial channel 18 therebetween. A spacing beam 19, which may be in the form of a box beam or a “Z” beam, extends transversely between the first side panel 15, and the second side panel 16, and is further located within the medial channel 18. The spacing beam 19 may be located at a position which is spacedly adjacent to the first end 11, and the bottom edge 14. The stationary base 10 has a given mass, and weight, as will be discussed in further detail hereinafter. The stationary base 10 further includes support feet brackets 20, and supporting feet 21, which locate or orient the stationary base 10 in a spaced relationship relative to the underlying supporting surface 200. (FIG. 1). The supporting feet 21 may include resilient members to dampen, or otherwise dissipate, vibrational forces, which may be experienced by, or imparted to, the stationary base 10, and prevent these vibrational forces from being transmitted to the underlying supporting surface 200. Additionally, and as seen in FIG. 5, a plurality of pairs of spring support holes 22 are defined or formed in the first and second side panels 15, 16 and oriented in a predetermined spacedly adjacent locations near the top edge 13. The spring support holes 22 cooperate with or carry frame spring supports 131 for the support frame 130 as will be discussed hereinafter.

The support frame 130 (FIG. 5) comprises a plurality of frame spring supports 131 which are individually affixed, such as by welding or by means of releasable fasteners, to the first and second side panels 15, 16 respectively of the stationary base 10. The fasteners matingly cooperate with the spring support holes 22. The respective frame spring supports 131 are oriented and located in a given angular and spaced relationship one relative to the other, so as to position attached elongated resilient springs 132, 140, 148 in a given angular orientation relative to a spaced reciprocally movable, and elongated conveyor bed 170 which will be discussed in greater detail, herein.

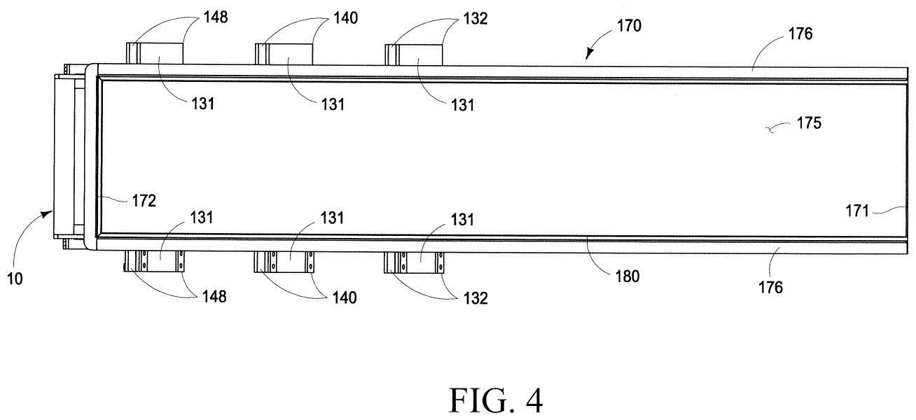

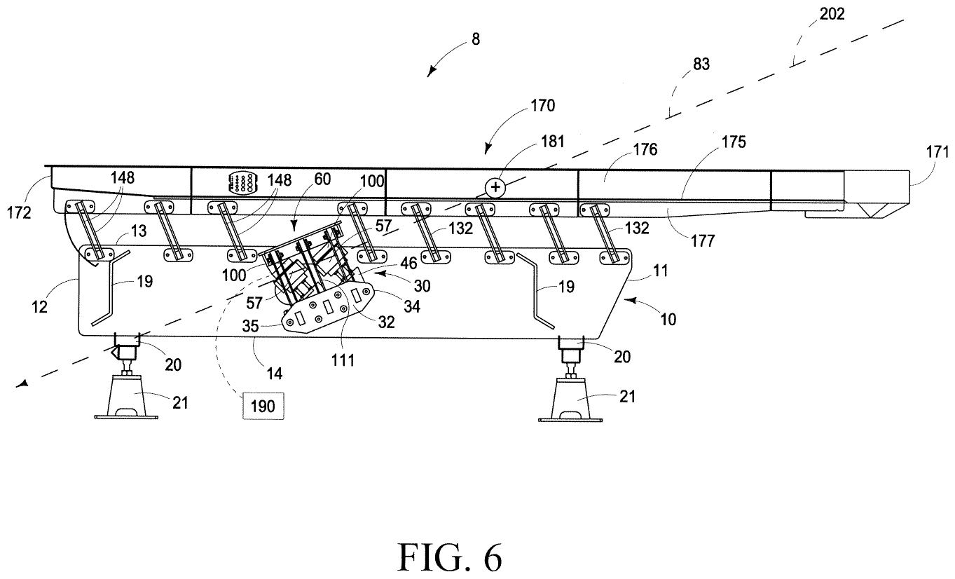

As seen in the accompanying Figures, the vibratory conveyor 8, 9 of the prevent invention includes a multiplicity of pairs of elongated and resilient springs 132, 140, 148 of conventional design. The multiplicity of pairs of elongated and resilient springs 132, 140, 148 include a first pair of elongated resilient springs 132; a second pair of elongated and resilient springs 140; and a third pair of elongated and resilient springs 148. It is expressly contemplated that additional pairs of elongated and resilient springs (FIG. 6), or fewer pairs of elongated and resilient springs may be used with the instant invention depending upon the length of the elongated reciprocally movable conveyor bed 170 which is supported thereby. In the first disclosed preferred embodiment (FIGS. 1-5), three pairs of elongated and resilient springs are used. In a second preferred embodiment (FIGS. 6-10) more than three pairs of elongated and resilient springs 132, 140, 148 may be utilized due to the increased length of the conveyor bed 170. Each of the individual elongated and resilient springs 132, 140, 148 comprising the multiplicity of pairs of elongated and resilient springs 132, 140, 148 has a predetermined free spring length, width, stiffness and material composition which together provide a spring constant in N/mm for each individual spring. The spring constant of each individual spring is utilized to calculate the total number of springs (pairs of springs) necessary to support the elongated conveyor bed 170 and to provide the desired frequency of reciprocal motion. Each of the respective pairs of elongated and resilient springs 132, 140, 148, has a first, lower end portion 133, 141 and 149 respectively and which are further individually mounted on each of the respective frame spring supports 131. The first, lower end portions 133, 141 and 149, and the second upper end portions 134, 142, 150 of each of the multiplicity of pairs of elongated and resilient springs defines fastener holes (not shown) to carry fasteners (not shown), and which extend therethrough. Further, a fastening plate, 136 144 and 152 may be used in conjunction with fasteners (not shown) which extend through the fastener holes (not shown) to provide a more secure and more durable interconnection between the elongated and resilient springs 132, 140 and 148 and the spring supports 131, 183. As earlier noted, the frame spring supports 131 are fastened to the stationary base 10.

A multiplicity of pairs of conveyor bed spring supports 183 are mounted to the reciprocally movable elongated conveyor bed 170 along support edge 177 by fastening means, such as by welding or using conventional fasteners, as will be described, herein. The second upper end portions 134, 142 and 150 of the respective elongated and resilient springs 132, 140 and 148 are attached to the respective pairs of conveyor bed spring supports 183 carried by the reciprocally movable elongated conveyor bed 170. Fastening plates 136, 144 and 152 may similarly be used to provide a secure interconnection at the second upper end portions 134, 142 and 150 of the elongated resilient spring legs 132, 140 and 148 to the conveyor bed spring supports 183.

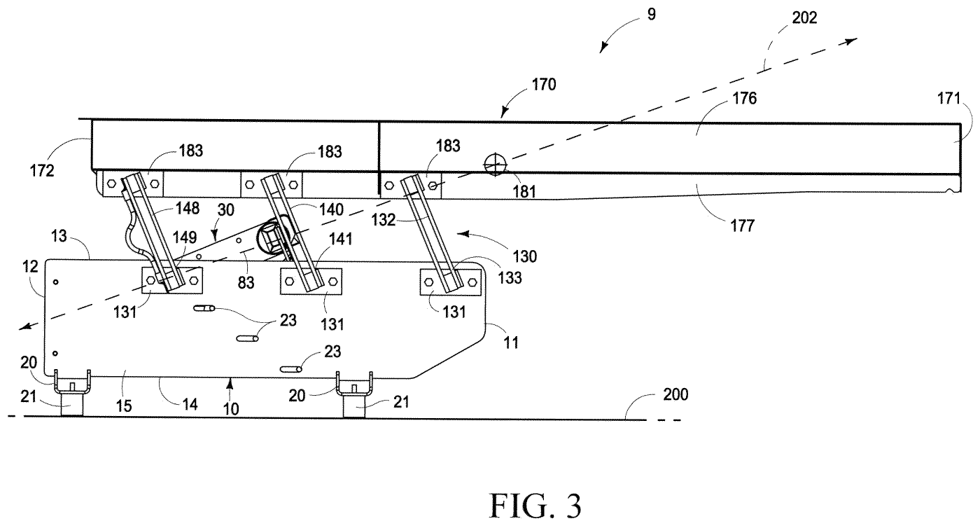

The multiplicity of pairs of elongated and resilient springs 132, 140 and 148 are oriented substantially along, and in spaced relation, relative to a longitudinal axis 182 of the reciprocally movable elongated conveyor bed 170, as will be discussed in greater detail, hereinafter. (FIG. 3).

The vibratory conveyor 8, 9 includes a reciprocally moveable and elongated conveyor bed 170 which is supported in predetermined spaced relation relative to both the supporting surface 200, and the stationary base 10, by the multiplicity of pairs of elongated and resilient springs 132, 140 and 148. The reciprocally moveable and elongated conveyor bed 170 is of substantially traditional design, and has a predetermined length, width, weight and mass. The reciprocally moveable and elongated conveyor bed 170 has a main body 180, which is shown in the accompanying figures as being generally narrowly rectangular in shape. The main body 180 further has a product conveying surface 175, which is substantially horizontally oriented. However, some forms of the invention may include a product conveying surface 175 which may be angled, slightly upwardly or slightly downwardly, so as to move a product 201 therealong. The product conveying surface 175 has a first end 171, and a spaced apart second end 172. The main body 180 further has a center of mass, which is generally indicated by the 181. (FIG. 3). The main body 180 further includes a pair of generally vertically extending sidewalls 176, and which are positioned on opposite sides of the product conveying surface 175, and which are further operable to confine the product 201 (FIG. 1) on the product conveying surface 175 for transport or movement between the second end 172 and in the direction of the first end 171. The product conveying surface 175 has an opposite, downwardly facing, bottom surface (not shown). A pair of elongated support edges 177 are carried on the bottom surface (not shown), and are oriented vertically below, and aligned with, each of the vertically extending side walls 176. Each support edge 177 defines plural spacedly arrayed conveyor spring support holes 179 (FIG. 5) and which facilitate the mounting of the respective conveyor spring supports 183 thereto as earlier noted. The main body 180 further has a longitudinal axis 182. Plural transversely oriented, and spaced apart strengthening cross members (not shown) extend between the respective support edges 177 along the bottom surface (not shown) so as to provide strength and rigidity to the reciprocally movable and elongated conveyor bed 170.

The present invention 9 includes a novel, magnetic drive assembly which is generally indicated by the numeral 30, and which is carried by the stationary base 10, and is located within the medial channel 18 which is defined by the stationary base 10. The drive assembly 30 includes a drive saddle 31, a weight holder 60 and plural pairs of spacedly arrayed spring arms 111 which will be described in detail, herein.

The drive assembly 30 (FIGS. 5-10) has a first side 32, and a second side 33. Each of the sides 32, 33 has a first end 34, and an opposing second end 35. The first side 32 and the second side 33 each have a laterally outer facing surface 36, and a laterally inner facing surface 37. Plural, spacedly arrayed fastener holes 44 are defined, or formed in each of the first side 32, and the second side 33 so as to provide a means for securing the drive assembly 30 within the medial channel 18, defined by the base 10. A crossbeam (not shown) extends transversely between the laterally inner facing surfaces 37 of the respective first side 32, and second side 33, and is generally oriented medially between the first end 34, and the second end 35.

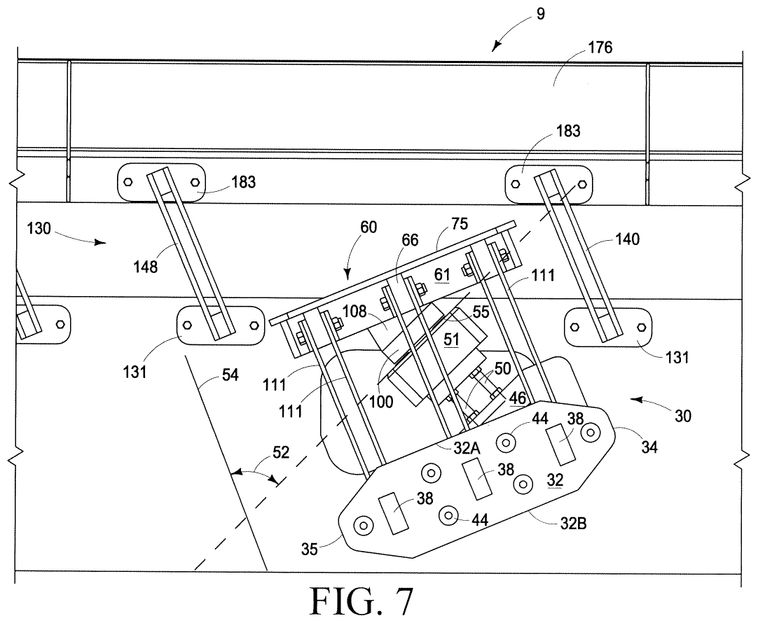

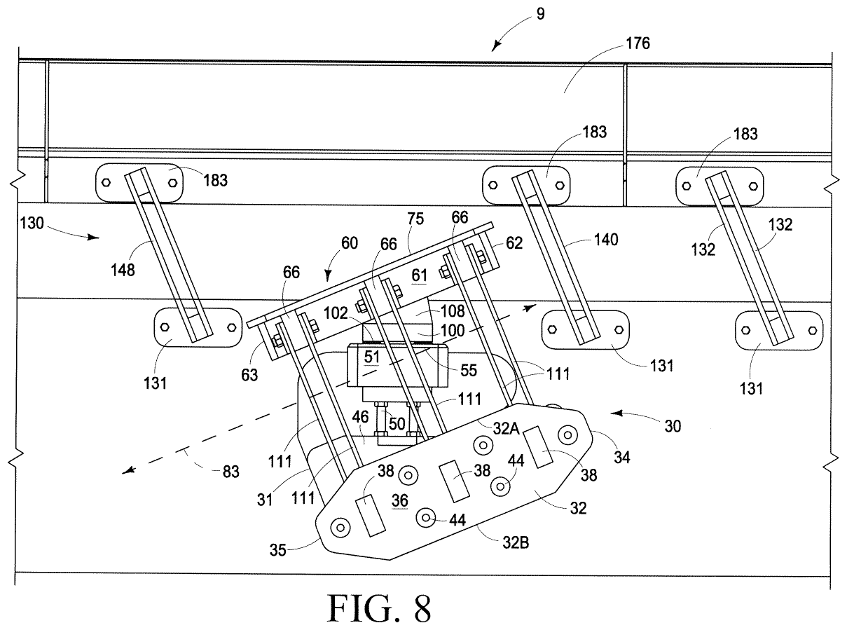

A magnet seat 46 (FIG. 7) is structurally carried by, or made integral with, the crossbeam (not shown) and extends angularly upwardly relative to a top surface of the crossbeam (not shown). The magnet seat 46 is preferably formed of a material that is not substantially magnetic and defines a predetermined angle 52 between the magnet seat 46 and an imaginary line 54 that extends parallel to the spring arms 111. The angle 52 is preferably between about 10° and 70°, and is most preferably between approximately 8° and 27° which provides for the desired resonant frequency to move product 201 along the conveying surface. As seen in a comparison of FIGS. 7 and 8, various angular orientations of the electromagnet 51 and the attractor plate 100, relative to one another, and relative to the spring arms 111 allow utilization of the same angle 52 to provide the desired reciprocal motion.

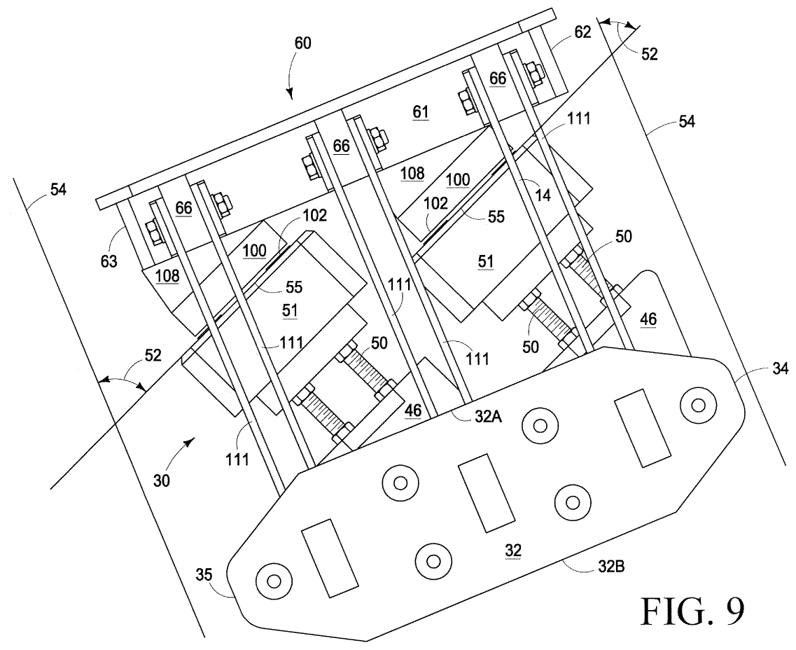

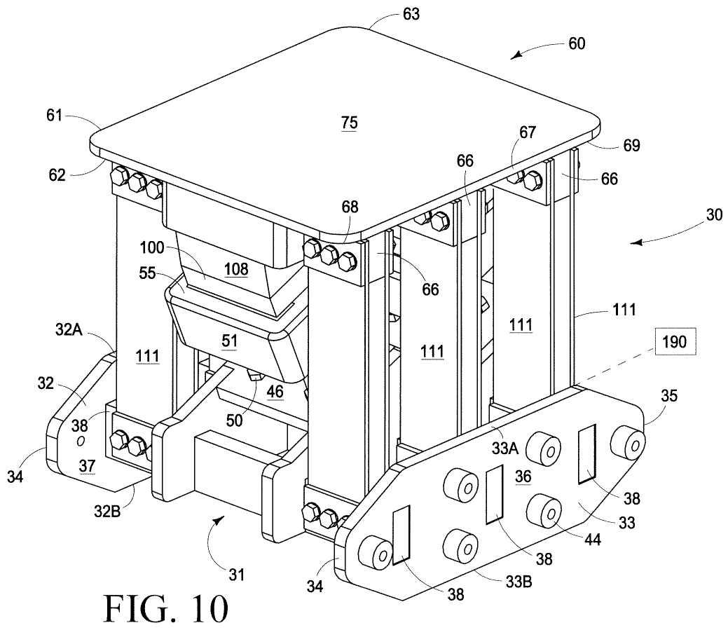

In a particularly preferred embodiment, a single (one) electromagnet 51 and a single (one) attractor plate 100 is utilized (FIGS. 8, 9). In other contemplated embodiments, plural electromagnets 51 and plural attractor plates 100 may be utilized and in such instances, the orientation of each electromagnet 51 and each attractor plate 100 is the same relative to its adjacent electromagnet 51/attractor plate 100. (See FIGS. 7, 10). In a still further contemplated embodiment, plural spacedly arrayed drive assemblies 30 may be utilized to power a single reciprocally moveable elongated conveyor bed 170 that has a length which requires plural drive assemblies 30. In such a still further contemplated embodiment, the plural drive assemblies 30 would be spaced outwardly from the line of reference/work plane and each of the plural drive assemblies would be controlled by a single controller 190 so as to maintain the required synchronicity of the plural drive assemblies 30.

Gussets or support members (not shown) are structurally carried on a bottom surface of the magnet seat 46, and are further located at each of the lateral edges thereof. The gussets provide strength and rigidity to the magnet seat 46, and further to maintain the predetermined angle 52. A plurality of spacedly arrayed fastener holes (not shown) are defined or formed in the magnet seat 46 so as to carry, or cooperate with, mounting rods 50. The mounting rods 50 positionally, and adjustably carry the electromagnet 51 which is oriented in a predetermined position relative to the magnet seat 46. The mounting rods 50 provide a means for adjustably positioning the electromagnet 51 relative to the magnet seat 46 and relative to the attractor plate 100. In the disclosed embodiment, the mounting rods 50 defined threads which allow for precise spatial adjustments and positioning of the electromagnet 51 so as to ensure the electromagnet 51 is oriented as desired relative to the magnet seat 46, and substantially parallel to, and at a desired distance relative to the attractor plate 100 carried by the weight holder 60, as will be discussed hereinafter.

Plural spacedly arrayed spring arm mounts 38 are carried on the laterally inner facing surface 37 of the first side 32, and generally medially between top edge 32A and a bottom edge 32B. Similarly plural spacedly arrayed spring arm mounts 38 are carried on the laterally inner facing surface 37 of the second side 33, and generally medially between top edge 33A and a bottom edge 33B. A resilient spring arm 111 (or pair of spring arms 111) is carried by each spring arm mount 38. The resilient spring arm 111 extends generally angularly upwardly therefrom and is operable to mount and positionally carry, or orient, the weight holder 60 in predetermined spaced relation relative to the drive saddle 31. The plural spacedly arrayed resilient spring arms 111 provide for, and facilitate, reciprocal movement of the weight holder 60 relative to the electromagnet 51 carried by the drive saddle 31.

The weight holder 60 (FIGS. 7-10) has a first side 61, and an opposing and parallel second side 67. The first side 61, and the second side 67 each have a first end 62 and 68 respectively, and a second end 63 and 69 respectively. A mounting block 108 is carried by the weight holder 60 on a surface proximate to the electromagnet 51 carried by the drive saddle 31. The mounting block 108 is angular relative to a top surface 75 of the weight holder 60 so as to carry an attractor plate 100 thereon, at a position spacedly adjacent to and parallel to the generally planar top surface 53 of the electromagnet 51. The attractor plate 100 is formed of a ferromagnetic material, such as steel, iron, or a composite which electromagnets 51 are attracted to, and/or repelled from in response to a predetermined applied magnetic field. In one contemplated embodiment (not shown) a plurality of spacedly arrayed fastener holes may be defined in, or formed in, the mounting block 108 to provide mounting locations for mounting rods (not shown) to provide positional adjustability of the attractor plate 100 relative to the electromagnet 51.

Plural spacedly arrayed spring arm mounts 66 are carried by each of the first side 61, and the second side 67 and at predetermined locations thereon. The respective spring arm mounts 66 interconnect or cooperate with the spring arms 111, and which are carried by the drive saddle 31. The spring arms 111 are of known construction and are resilient so as to facilitate a reciprocal movement of the weight holder 60 relative to the drive saddle 31 along a predetermined course of travel 83, (FIG. 6) also known as the “work plane” when the electromagnet 51 is selectively energized and selectively deenergized. Further, the spring arms 111 positionally maintain the weight holder 60 in a predetermined spaced relationship relative to the drive saddle 31.

The drive assembly 30 has a predetermined weight and a predetermined mass, and the spring arms 111 support the weight holder 60 relative to the drive saddle 31. The spring arms 111 are further oriented substantially parallel to elongated resilient spring legs 132, 140, 148 that support the elongated conveyor bed 170 relative to the stationary base 10. The center of mass of the drive assembly 130 is substantially in line with the center of mass 181 of the elongated conveyor bed 170. The weight holder 60 moves reciprocally along a course of travel 83 that is substantially co-linear with the line of reference 202 that passes through the center of mass 181 of the elongated conveyor bed 170. It is to be noted that the position of the center of mass 181 of any elongated conveyor bed 170 changes as the length of the conveyor bed increases/decreases. The total spring constant of the spring arms 111 and the total mass of the weight holder 60 provide for the resonance frequency of the drive assembly 130.

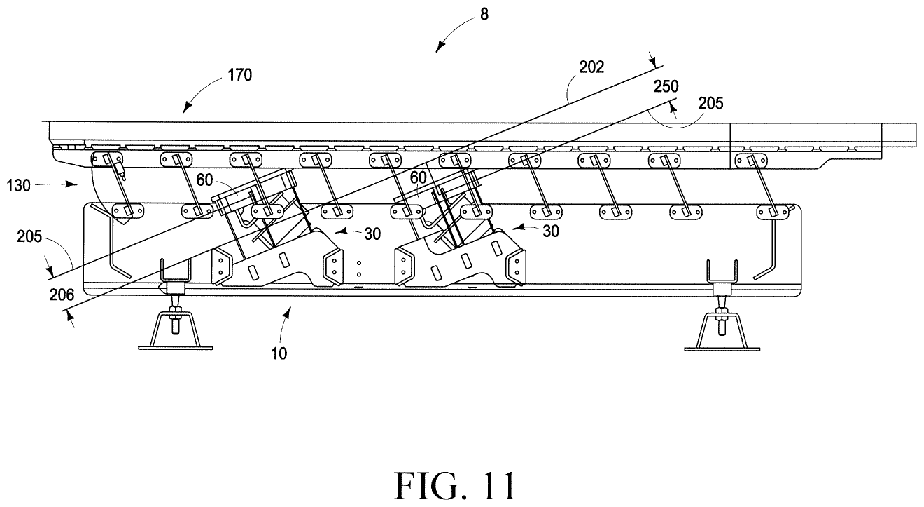

FIG. 11 shows a contemplated elongated conveyor 170 having plural multiple electro-magnet 51 drive assemblies 30 utilized to drive an elongated conveyor bed 170. It is to be expressly understood however, that more than two drive assemblies 130, each having one or plural electro-magnets 51 may be utilized to power long conveyor beds 170. In the contemplated elongated vibratory conveyor shown in FIG. 11, each of the two multi-magnet drive assemblies 130 reciprocally move the respective weight holder 60 along a line of travel 205 that is parallel to, and spaced apart from the conveyor 170 line of reference 202, by a predetermined distance 206. Each of the plural drive assembly's 30 line of travel 205 is spaced apart from the line of reference 202 by distance that is the same for each of the plural drive assemblies 30.

In the embodiment as illustrated in FIG. 6, the electromagnet 51 has an electrical lead (not shown) for interconnection, or electrical coupling, with a controller 190. The controller 190 communicates with, or is coupled to an electrical power source (not shown). The electromagnet 51 has a main body and is preferably generally rectilinear in shape, although other configurations and shapes are anticipated including, but not limited to, round, oval, polygonal and the like. The electromagnet 51 has a generally planar interaction surface 55 which is positioned proximate to, and parallel to, the generally planar interaction surface 102 of the attractor plate 100 carried by the weight holder 60. The generally planar interaction surface 55 allows for the electromagnet 51 to be positioned/oriented in close proximity to a generally planar interaction surface 102 of the attractor plate 100. (FIG. 9). The spacing between the electromagnet 51 and its adjacent attractor plate 100 is chosen so as to create a desired reciprocal motion, with a desired stroke length, of the weight holder 60 relative to the drive saddle 31 when the controller 190 selectively energizes, and selectively deenergizes the electromagnet 51. In the disclosed embodiment, the spacing between the electromagnet 51, and the adjacent attractor plate 100 is typically in a range between approximately 1.0 mm and 10.0 mm. In one possible form of the invention, the spacing is about 4.0 mm, The mounting rods 50 which carry or support the electromagnet 51, as noted previously, are preferably threaded to allow the position of the electromagnet 51 to be selectively adjustable relative to the adjacent attractor plate 100 so as to maintain the preferred spacing therebetween. The weight holder 60 and the attractor plate 100 has given mass which facilitates the operation of the present invention.

When selectively energized by the controller 190, which operatively directs electrical energy having a predetermined voltage and amperage to the electromagnet 51, the electromagnet 51 periodically (at a predetermined frequency and amplitude) attracts/draws toward its generally planar top surface 53 the attractor plate 100 and the supporting weight holder 60 in a first direction, which responsively biases/deflects the plurality of spacedly arrayed spring arms 111 away from a resting position and to a position having potential energy. Thereafter, when selectively deenergized by the controller 190 which interrupts the passage of electrical energy to the electromagnet 51. the plurality of spacedly arrayed spring arms 111, the attractor plate 100 and the attached/supporting weight holder 60 convert the potential energy into kinetic energy and responsively return/reciprocate the attractor plate 100, the weight holder 60 and the plurality of spacedly arrayed spring arms 111 in a second direction that is opposite the first direction. The sequential selective energizing and the deenergizing of the electromagnet 51 generates a predetermined, physical force, which is directed along a line of reference 202 (FIG. 6), and which is directed through the center of mass 181 of the reciprocally moveable elongated conveyor bed 170 and substantially through the center of mass of the drive assembly 30.

The sequential magnetic activation, and the sequential deactivation is affected by the controller 190 at a predetermined frequency. In the disclosed embodiment, the frequency is in a range of between approximately 5.0 Hz and 40.0 Hz. The resonance frequency of the elongated conveyor bed 170 is preferably between about 0.75 Hz and 3.5 Hz higher than the resonance frequency of the drive assembly 130, The resulting reciprocal motion of the weight holder 60 and which carries the attractor plate 100 imparts. reciprocal motion to the elongated conveyor bed 170, so as to cause movement of the product 201 between the second and first ends 172 and 171 thereof. Varying the electrical power supplied to the electromagnet 51 varies the speed of the product 201 movement along the product carrying surface 175. An accelerometer (not shown) may be carried by the drive assembly 30. The accelerometer may provide frequency and amplitude information to controller 190 and further provides monitoring of the operation of the drive assembly 30.

Referring now to FIG. 6, a greatly simplified arrangement for rendering the present invention 9 operational, is shown. In this arrangement, it will be seen that the controller 190 can, in one form of the invention, constitute a regular, general purpose computer, and is further coupled in controlling relation relative to the vibratory conveyor 9. The controller 190 generates an appropriate electrical signal and output, and which is then provided to the respective electromagnet 51 so as to energize the same, and produce reciprocal movement of the weight holder 60 relative to the drive saddle 31, and which is further made integral therewith. An operator, not shown, therefore may use the controller 190 to change both the frequency and the amplitude of the electrical current provided to the electromagnet 51, so as to effect the resulting vibratory motion imparted to the reciprocally moveable elongated conveyor bed 170. This allows the vibratory conveyor 8, 9 to be immediately, and dynamically adjusted, based upon the operational conditions being experienced by the reciprocally moveable elongated conveyor bed 170. Further, this arrangement also allows for the simultaneous and selective energizing of the electromagnet 51, in a given manner, so as to avoid the prior art problems which are associated with ramping up, or ramping down of an out-of-balance motor through given resonance modes, which may be possessed by the reciprocally moveable elongated conveyor bed 170. Because this problem is substantially eliminated lighter gauge materials can be used to fabricate the base 10 and elongated conveyor bed 170. This reduced gauge material results in lower costs to fabricate the conveyor device 8, 9. This arrangement also avoids many of the problems associated with the bending and twisting and yawing of any elongated conveyor bed 170, as previously experienced, and when using the prior art out-of-balance motors heretofore. Still further, and because of this arrangement, the earlier “tuning” which was utilized, heretofore, with regard to out-of-balance motors has been substantially eliminated. Moreover, as a result, the controller 190 may be utilized to precisely fine-tune or adjust the operation of the vibratory conveyor 8, 9, thus eliminating the need for high degrees of precision when assembling the vibratory conveyor 9, as was previously the case with prior art excited frame conveyors which have been utilized in the past. Additionally, and in one possible form of the invention, other sensors (not shown) may be deployed on the reciprocally moveable elongated conveyor bed 170, and/or the drive assembly 30, or components thereof, and which can provide feedback to the controller 190, in order to further fine tune or precisely adjust the operation of the vibratory conveyor 9 in a manner which has been not possible heretofore.

Those skilled in the art will recognize that the relative positions of the electromagnet 51, and the associated attractor plate 100 could be reversed. In this possible arrangement the attractor plate 100 would be carried by the drive saddle 31, and the electromagnet 51 would be carried by the weight holder 60. To render this arrangement operational the respective electromagnet 51 would increase in mass so as to generate the force necessary to effect the resulting reciprocal motion of the elongated conveyor bed 170.

### Operation

The operation of the described embodiment of the present invention is believed to be readily apparent and are briefly summarized at this point.

In its broadest aspect, the prevent invention relates to a vibratory conveyor 8, 9 which includes a reciprocally moveable elongated conveyor bed 170, and which has a product conveying surface 175. A magnetic drive assembly 30 is provided, and which is oriented in spaced relation relative to the reciprocally movable elongated conveyor bed 170. When energized, the drive assembly 30 imparts reciprocal motion to the elongated conveyor bed 170 to move a product 201 along the product conveying surface 175, of the reciprocally movable elongated conveyor bed 170. The present invention also includes a stationary base 10, which is positioned on an adjacent supporting surface 200, and which supports the reciprocally moveable elongated conveyor bed 170 in spaced relation relative to the supporting surface 200, The vibratory conveyor 8, 9 further includes a multiplicity of pairs of elongated and resilient springs 132, 140 and 148, which couple the reciprocally moveable and elongated conveyor bed 170 to the stationary base 10. The multiplicity of pairs of elongated and resilient springs 132, 140 and 148 locate the reciprocally moveable and elongated conveyor bed 170 in spaced relation relative to the stationary base 10. In the arrangement as seen in FIG. 1, and following, the reciprocally moveable and elongated conveyor bed 170 has a longitudinal axis 182. The respective pairs of elongated and resilient spring legs 132, 140 and 148 are oriented in predetermined, spaced relation relative to the longitudinal axis 182 of the reciprocally moveable elongated conveyor bed 170.

The drive assembly 30 is mounted on the stationary base 10. When the electromagnet 51 is energized, the sequential magnetic attraction relative to the attractor plate 100 and which is carried by the weight holder 60 reciprocates the weight holder 60 in a manner so as to generate a predetermined force, which is directed along the given line of reference 202 (FIG. 6) and which passes through the center of mass 181 of the reciprocally moveable elongated conveyor bed 170 and substantially through the center of mass of the drive assembly 30. In all the forms of the invention as disclosed, the controller 190 as provided is coupled to the respective electromagnet 51, and further controls the reciprocal movement of the weight holder 60, so as to effect the subsequent movement of the product 201, along the product conveying surface 175 of the reciprocally moveable elongated conveyor bed 170 in a manner not possible heretofore.

In all forms of the invention as described, the reciprocally moveable elongated conveyor bed 170 has a natural reciprocal frequency which affects an optimal movement of the product 201 along the conveying surface 175. In this regard, the weight of the respective attractor plate 100, in combination with the weight and mass of the weight holder 60, is selected so as to impart the natural reciprocal frequency to the reciprocally moveable and elongated conveyor bed 170. In all forms of the invention, the reciprocally moveable and elongated conveyor bed 170 has a maximum reciprocal stroke, and wherein the product 201 can move along the product conveying surface 175, and a variably adjustable speed up to the maximum reciprocal stroke attributable to the reciprocally moveable elongated conveyor bed 175 which is employed. In the disclosed embodiment, the reciprocal stroke is located in a range of between approximately 2 mm and 40 mm, although the reciprocal stroke may be adjusted depending upon the product 201 being transported upon the product conveying surface 175.

It should be understood that each of the stationary base 10 and the reciprocally movable and elongated conveyor bed 170, as depicted and described, have individual weights and masses, and wherein the ratio of the weight of the stationary base 10, to the weight of the reciprocally movable and elongated conveyor bed 170 is about 50% to about 125%. In the arrangement as seen in the drawings, the reactive mass, which comprise the respective attractor plate 100 and the weight holder 60 typically has a weight of about 27 Kg to about 33 Kg and the weight of the reciprocally movable and elongated conveyor bed 170 is about 36 Kg to about 44 Kg. Still further, when the electromagnet 51 is energized, the electromagnet 51 and the weight holder 60 reciprocate at a frequency of about 5.0 Hz. to about 30 Hz. further, the voltage and amperage supplied to the respective electromagnet 51 by the controller 190 may be varied and adjusted so as to maximize the desired rate of movement of the product 201 along the product conveying surface 175.

A principal object of the present invention is a vibratory conveyor, having one electromagnet, and one attractor plate.

A further object of the present invention is a vibratory conveyor, comprising a base having opposite first and second ends, and opposite sides which are spaced apart a predetermined distance, and wherein a medial channel is defined between the opposite sides; an elongated conveyor bed which is moveably mounted on, and disposed in spaced relation relative to the base, and wherein the elongated conveyor bed has opposite first and second ends, and a center of mass, and wherein the elongated conveyor bed has a supporting surface which carries a product which is movable between the first and second ends thereof when the elongated conveyor bed is reciprocally moved in a predetermined manner; a first multiplicity of elongated resilient spring legs, each of the first multiplicity of elongated resilient spring legs having a first end which is mounted on the base, and a second end which is mounted on the elongated conveyor bed, and the first multiplicity of elongated resilient spring legs are positioned at a predetermined angle relative to both the base and the elongated conveyor bed, and the first multiplicity of elongated resilient spring legs reciprocally support the elongated conveyor bed spacedly adjacent to the base so as to effect movement of the product along the supporting surface of the conveyor bed; and a drive assembly borne by the base, and located within the medial channel defined by the base, and wherein the drive assembly includes a drive saddle which defines a magnet seat, and wherein the magnet seat is at a predetermined angular orientation, relative to the base, and wherein an electromagnet is adjustably carried on the magnet seat, and the drive saddle further includes a multiplicity of spacedly arrayed spring mounts located in a predetermined spacedly arrayed pattern; and a second multiplicity of spring arms and each of the second multiplicity of spring arms has a first end mounted on one of the multiplicity of spacedly arrayed spring mounts of the drive saddle, so as to extend outwardly therefrom at a predetermined angle, and wherein each of the respective second multiplicity of spring arms has a distal second end spaced apart from the drive saddle; and a weight holder interconnected at the second ends of each of the second multiplicity of spring arms in a predetermined, spaced relationship relative to the drive saddle, and wherein the weight holder carries an attractor plate in a given angular, and spaced orientation relative to the electromagnet carried by the drive saddle, and wherein the weight holder, and the attractor plate carried thereby have a total given mass, and the total given mass is reciprocally moveable along a line of force/work plane which extends substantially through a center of mass of the drive assembly and substantially through the center of mass of the elongated conveyor bed; and wherein selective energizing and selective de-energizing of the electromagnet sequentially draws toward, and releases the attractor plate to/from the energized/deenergized electromagnet which responsively generates a reciprocal motion of the weight holder, and wherein the reciprocal motion generates a force along the line of force/work plane which effects a corresponding reciprocal motion of the elongated conveyor bed, and a responsive movement of the product along the supporting surface thereof.

A further object of the present invention is a vibratory conveyor wherein the electromagnetic has a generally planar interaction surface; and the attractor plate has a generally planar interaction surface; and both the generally planar interaction surfaces are oriented parallel to one another and angular relative to the second multiplicity of spring arms.

A further object of the present invention is a vibratory conveyor wherein the electromagnetic has a generally planar interaction surface; and the attractor plate has a generally planar interaction surface; and both the generally planar interaction surfaces are oriented generally horizontally and parallel to a product conveying surface of the elongated conveyor bed.

A further object of the present invention is a vibratory conveyor wherein selective activation of the electromagnet generates a magnetic field which responsively draws the attractor plate, and the weight holder, in a first direction of movement and into closer proximity to the energized electromagnet; and selective deactivation of the electromagnet allows the second multiplicity of spring arms to bias the weight holder and the attractor plate into a second direction of movement, and the second direction of movement is opposite the first direction of movement.

A further object of the present invention is a vibratory conveyor wherein an angle between the second multiplicity of spring arms that support the weight holder and attractor plate in angular spaced relation relative to the drive saddle, and a line extending parallel to a generally planar interaction surface of the electromagnet is between approximately 10° and 70°.

A further object of the present invention is a vibratory conveyor wherein an angle between the second multiplicity of spring arms that support the weight holder and attractor plate in angular spaced relation relative to the drive saddle, and a line extending parallel to a generally planar interaction surface of the electromagnet is preferably between approximately 15° and 45°.

A further object of the present invention is a vibratory conveyor wherein an angle between the second multiplicity of spring arms that support the weight holder and attractor plate in angular spaced relation relative to the drive saddle, and a line extending parallel to a generally planar interaction surface of the electromagnet is 22.5°.

A further object of the present invention is a vibratory conveyor wherein the magnet seat defines a plurality of spacedly arrayed holes for receiving individual mounting posts which adjustably position and carry the electromagnet.

A further object of the present invention is a vibratory conveyor wherein the second multiplicity of spring arms are mounted on, and communicate between the weight holder spring arm mount, and the drive saddle spring arm mount to support the weight holder in a predetermined spaced orientation relative to the drive saddle.

A further object of the present invention is a vibratory conveyor wherein the selectively energizable electromagnet, when rendered operable, magnetically draws the attractor plate into closer proximity to the energized electromagnet which responsively deflects/biases each of the second multiplicity of spring arms in a first direction resulting in an accumulation of potential energy in each of the deflected second multiplicity of spring arms.

A further object of the present invention is a vibratory conveyor wherein the magnetic attraction of the attractor plate to the selectively energizable electromagnet effects movement of the weight holder in a first direction towards the electromagnet responsive to the electromagnet to receiving the electrical power from the controller; and biasing return movement of the weight holder in a second direction is caused by selective deactivation of the electromagnet and release of stored potential energy from the second multiplicity of spring arms which generate movement of the weight holder along the predetermined line of reference/work plane in a second direction.

A further object of the present invention is a vibratory conveyor wherein a magnetic field generated by the selectively activated electromagnet may be periodically activated and deactivated by the controller so as to cause the weight holder to reciprocally move relative to the drive saddle at a desired frequency, and amplitude, along a line of reference/work plane that passes through a center of mass of the drive assembly.

A further object of the present invention is a vibratory conveyor wherein a frequency and an amplitude of the movement of the weight holder may be altered by the controller.

A further object of the present invention is a vibratory conveyor wherein the generated reciprocal force, and the resulting reciprocal motion of the elongated conveyor bed effects movement of product along the product transporting surface of the elongated conveyor bed, and between the first and second ends of the elongated conveyor bed.

A further object of the present invention is a vibratory conveyor, comprising a base having a first side, and a spaced apart, and parallel, second side, and wherein the first and second sides each have a first end, a second end, a top edge and a bottom edge, and wherein an end panel communicates between the first side, and the second sides at one end thereof, and wherein the base further defines a medial channel which is located between the first and second sides; a drive assembly which is borne by the base, and is further carried within the medial channel, and wherein the drive assembly comprises a drive saddle, a weight holder, and a selectively energizable electromagnet, and wherein the drive saddle has a first side, and a parallel, spaced apart, second side, and wherein each side has a first end, and a second end, and wherein each side further has a laterally outwardly facing surface, and an opposing, laterally inwardly facing surface, and wherein a crossbeam structurally communicates between the first side, inwardly facing surface, and the second side, inwardly facing surface, and wherein the crossbeam structurally carries a magnet seat between the first side, and the second side, and at a location which is generally medial between the first end and the second end, and wherein the magnet seat further defines a plurality of spaced holes for receiving mounting posts which adjustably position and carry a selectively energizable electromagnet, and wherein the first and the second sides each carry a plurality of spacedly arrayed spring arm mounts on the laterally inwardly facing surfaces, and wherein each of the plurality of spring arm mounts carries an elongated spring arm; and the plurality of elongated spring arms movably support to the weight holder in a spaced orientation relative to the drive saddle; and wherein the weight holder has a first side, and a spaced apart, and parallel, second side, and wherein each of the first and second sides has a first end, and a second end, and wherein a mounting block is carried between the first side, and the second side, and the mounting block carries an attractor plate, and wherein the weight holder first and second sides, each carry a plurality of spacedly arrayed spring arm mounts on a laterally outwardly facing surface thereof, and the individual elongated spring arms are mounted on each of the plurality of spacedly arrayed spring arm mounts carried by the weight holder, and to the plurality of spring arm mounts carried by the drive saddle to support the weight holder in the spaced orientation relative to the drive saddle; and wherein the selectively energizable electromagnet mounted on the magnet seat of drive saddle, when rendered operable, sequentially, and magnetically attracts, the attractor plate which is carried by the weight holder when electrical energy is selectively supplied to the electromagnet by a controller which responsively draws the attractor plate closer to the selectively energizable magnet and correspondingly deflects/biases the multiplicity of spring arms in a first direction; and wherein when the selectively energizable magnet is deenergized, the multiplicity of spring arms return to an unbiased position effectively moving the weight holder in a second direction opposite the first direction, and wherein the movement of the weight holder generates a force along a predetermined line of reference/work plane; an elongated conveyor bed having opposite first and second ends, a top surface defining a product transporting surface which supports a product for movement between the respective opposite ends of the elongated conveyor bed, and a bottom surface, and wherein the elongated conveyor bed is reciprocally and resiliently supported in spaced relation relative to the base, and wherein the elongated conveyor bed has a center of mass through which the predetermined line of reference passes; a multiplicity of elongated resilient spring legs which individually, and resiliently support the elongated conveyor bed in spaced relation relative to the base, and wherein each of the multiplicity of elongated resilient spring legs each have a respective first end which is fixedly attached to the base, and an opposite second end, which is fixedly affixed to the elongated conveyor bed; and a controller which electrically and operationally communicates with a source of electrical power, and wherein the controller selectively supplies electric power to the selectively energizable electromagnet so as to cause the electromagnet to generate a magnetic field, and wherein when the selectively energizable electromagnet is energized by the controller the generated magnetic field draws the attractor plate into closer proximity to the energized selectively energizable electromagnet, thereby causing the weight holder to reciprocally move relative to the drive saddle at a desired frequency, and amplitude, and along the line of reference/work plane, and wherein the frequency of the weight holder movement may be adjusted by the controller, and wherein the reciprocal movement of the weight holder relative to the drive saddle generates a predetermined amount of vibratory force which is imparted to the elongated conveyor bed, so as to effect reciprocal motion of the elongated conveyor bed, and facilitate the movement of the product along the product transporting surface.

A still further object of the present invention is a vibratory conveyor further comprising: a second selectively energizable electromagnet carried by the drive saddle; and a second attractor plate carried by the weight holder.

A still further object of the present invention is a vibratory conveyor wherein the selectively energizable electromagnet is carried by the weight holder; and the attractor plate is carried by the drive saddle.

An even still further object of the present invention is a drive assembly for a vibratory conveyor comprising: a selectively energizable electromagnet; and an attractor plate spaced apart from the selectively energizable electromagnet a predetermined distance; and a plurality of spacedly arrayed elongated springs interconnecting, and communicating between a drive saddle that carries the selectively energizable electromagnet, and a weight holder that carries the attractor plate; and wherein selective energizing of the selectively energizable electromagnet causes the selectively energizable electromagnet to generate a magnetic field which draws the attractor plate, and the weight holder, into a first direction of movement and into closer proximity to the energized selectively energizable electromagnet; and selective deenergizing of the selectively energizable electromagnet allows the plurality of spacedly arrayed elongated springs to bias the attractor plate, and the weight holder, into a second to direction of movement and a distally from the selectively energizable electromagnet, and the second to direction of travel is opposite the first direction of travel; and selectively energizing and deenergizing the selectively energizable magnet generates reciprocal vibration that is communicated to an elongated conveyor.

An even still further object of the present invention is a vibratory conveyor, comprising: an elongated, reciprocally movable conveyor bed for carrying a product along a path of travel, and wherein the elongated reciprocally movable conveyor bed has a center of mass; a base for supporting the elongated reciprocally movable conveyor bed relative to a supporting surface; a multiplicity of spacedly arrayed elongated springs extending from the base, and supporting the reciprocally movable conveyor bed in spaced, reciprocally movable relation relative to the base; and a drive assembly carried by the base, the drive assembly having a weight holder that has an attractor plate, a total predetermined weight and a center of mass, and the drive assembly further has a selectively energizable electromagnet that is spaced apart, a predetermined distance, from the attractor plate, and wherein selective energizing and selective de-energizing of the electromagnet effects a reciprocal motion of the weight holder and attractor plate relative to the selectively energizable electromagnet so as to create a reciprocating force which extends along a predetermined line of reference/work plane which passes through the center of mass of the weight holder, and which is parallel to a line passing through the center of mass of the elongated reciprocally movable elongated conveyor bed, which affects the movement of the product along the path of travel of the conveyor bed; and a controller that selectively energizes and selectively de-energizes the selectively energization electromagnet

These and other objects of the present invention will be discussed in greater detail hereinafter.

Therefore, it will be seen that the present invention provides a convenient means for controlling the operation of a reciprocally moveable and elongated conveyor bed 170, in a manner not possible heretofore. The present invention is convenient, easy to operate, substantially avoids all the impediments and shortcomings of the prior art teachings utilized heretofore, and provides a means by which an operator can readily detect and then control the operation of the reciprocal elongated conveyor bed 170 in a manner to achieve selective and efficient delivery of particulate matter, to downstream manufacturing processes.

In compliance with the statute, the invention has been described in language more or less specific as to structural and methodical features. It is to be understood, however, that the invention is not limited to the specific features shown and described, since the means herein disclosed comprise preferred forms of putting the invention in effect. The invention is, therefore, claimed in any of its forms or modifications within the proper scope of the appended claims appropriately interpreted according to the Doctrine of Equivalence.

We claim:

1. A vibratory conveyor, comprising:
an elongated, reciprocally movable conveyor bed for carrying a product along a path of travel, and wherein the elongated reciprocally movable conveyor bed has a center of mass;
a base for supporting the elongated reciprocally movable conveyor bed relative to a supporting surface;
a multiplicity of spacedly arrayed elongated springs extending from the base, and supporting the reciprocally movable conveyor bed in spaced, reciprocally movable relation relative to the base; and
a drive assembly mounted on the base, the drive assembly having a predetermined weight and a center of mass, an attractor plate and a selectively energizable electromagnet that is spaced apart, a predetermined distance, from the attractor plate, and wherein selective energizing and selective de-energizing of the electromagnet effects a reciprocal motion of the attractor plate relative to the selectively energizable electromagnet so as to create a reciprocating force which extends along a predetermined line of reference/work plane which passes through the center of mass of the weight holder and passes through the center of mass of the elongated reciprocally movable elongated conveyor bed, which affects the movement of the product along the path of travel of the conveyor bed; and
a controller that selectively energizes and selectively de-energizes the selectively energization electromagnet.

2. The vibratory conveyor, as claimed in claim 1, and wherein there is one electromagnet, and one attractor plate,

3. A vibratory conveyor, comprising:
a base having opposite first and second ends, and opposite sides which are spaced apart a predetermined distance, and wherein a medial channel is defined between the opposite sides;
an elongated conveyor bed which is moveably mounted on, and disposed in spaced relation relative to the base, and wherein the elongated conveyor bed has opposite first and second ends, and a center of mass, and wherein the elongated conveyor bed has a supporting surface which carries a product which is movable between the first and second ends thereof when the elongated conveyor bed is reciprocally moved in a predetermined manner;
a first multiplicity of elongated resilient spring legs, each of the first multiplicity of elongated resilient spring legs having a first end which is mounted on the base, and a second end which is mounted on the elongated conveyor bed, and the first multiplicity of elongated resilient spring legs are positioned at a predetermined angle relative to both the base and the elongated conveyor bed, and the first multiplicity of elongated resilient spring legs reciprocally support the elongated conveyor bed spacedly adjacent to the base so as to effect movement of the product along the supporting surface of the conveyor bed; and
a drive assembly borne by the base, and located within the medial channel defined by the base, and wherein the drive assembly includes a drive saddle which defines a magnet seat, and wherein the magnet seat is at a predetermined angular orientation, relative to the base, and wherein an electromagnet is adjustably carried on the magnet seat, and the drive saddle further includes a multiplicity of spacedly arrayed spring mounts located in a predetermined spacedly arrayed pattern; and
a second multiplicity of spring arms and each of the second multiplicity of spring arms has a first end mounted on one of the multiplicity of spacedly arrayed spring mounts of the drive saddle, so as to extend outwardly therefrom at a predetermined angle, and wherein each of the respective second multiplicity of spring arms has a distal second end spaced apart from the drive saddle; and
a weight holder interconnected at the second ends of each of the second multiplicity of spring arms in a predetermined, spaced relationship relative to the drive saddle, and wherein the weight holder carries an attractor plate in a given angular, and spaced orientation relative to the electromagnet carried by the drive saddle, and wherein the weight holder, and the attractor plate carried thereby have a total given mass, and the total given mass is reciprocally moveable along a line of force/work plane which extends substantially through a center of mass of the drive assembly and substantially through the center of mass of the elongated conveyor bed; and wherein
selective energizing and selective de-energizing of the electromagnet sequentially draws toward, and releases the attractor plate to/from the energized/deenergized electromagnet which responsively generates a reciprocal motion of the weight holder, and wherein
the reciprocal motion generates a force along the line of force/work plane which effects a corresponding reciprocal motion of the elongated conveyor bed, and a responsive movement of the product along the supporting surface thereof.

4. The vibratory conveyor as claimed in claim 1, and wherein the electromagnetic has a generally planar interaction surface; and
the attractor plate has a generally planar interaction surface; and
both the generally planar interaction surfaces are oriented parallel to one another and angular relative to the second multiplicity of spring arms.

5. The vibratory conveyor as claimed in claim 1, and wherein the electromagnetic has a generally planar interaction surface; and
the attractor plate has a generally planar interaction surface; and
both the generally planar interaction surfaces are oriented generally horizontally and parallel to a product conveying surface of the elongated conveyor bed.

6. The vibratory conveyor as claimed in claim 1, and wherein selective activation of the electromagnet generates a magnetic field which responsively draws the attractor plate, and the weight holder, in a first direction of movement and into closer proximity to the energized electromagnet; and
selective deactivation of the electromagnet allows the second multiplicity of spring arms to bias the weight holder and the attractor plate into a second direction of movement, and the second direction of movement is opposite the first direction of movement.

7. The vibratory conveyor as claimed in claim 1, and wherein an angle between the second multiplicity of spring arms that support the weight holder and attractor plate in angular spaced relation relative to the drive saddle, and a line extending parallel to a generally planar interaction surface of the electromagnet is between approximately 10° and 70°.

8. The vibratory conveyor as claimed in claim 1, and wherein an angle between the second multiplicity of spring arms that support the weight holder and attractor plate in angular spaced relation relative to the drive saddle, and a line extending parallel to a generally planar interaction surface of the electromagnet is preferably between approximately 15° and 45°.

9. The vibratory conveyor as claimed in claim 1, and wherein an angle between the second multiplicity of spring arms that support the weight holder and attractor plate in angular spaced relation relative to the drive saddle, and a line extending parallel to a generally planar interaction surface of the electromagnet is 22.5°.

10. The vibratory conveyor as claimed in claim 1, and wherein the second multiplicity of spring arms are mounted on, and communicate between the weight holder spring arm mount, and the drive saddle spring arm mount to support the weight holder in a predetermined spaced orientation relative to the drive saddle.

11. The vibratory conveyor as claimed in claim 1, and wherein the selectively energizable electromagnet, when rendered operable, magnetically draws the attractor plate into closer proximity to the energized electromagnet which responsively deflects/biases each of the second multiplicity of spring arms in a first direction resulting in an accumulation of potential energy in each of the deflected second multiplicity of spring arms; and
deactivation of the selectively energizable electromagnet permits each of the second multiplicity of spring arms to release the accumulated potential energy in a second direction which is opposite the first direction.

12. The vibratory conveyor as claimed in claim 1, and wherein the magnetic attraction of the attractor plate to the selectively energizable electromagnet effects movement of the weight holder in a first direction towards the electromagnet responsive to the electromagnet to receiving the electrical power from the controller; and
biasing return movement of the weight holder in a second direction is caused by selective deactivation of the electromagnet and release of stored potential energy from the second multiplicity of spring arms which generate movement of the weight holder along the predetermined line of reference/work plane in a second direction.

13. The vibratory conveyor as claimed in claim 1, and wherein a magnetic field generated by the selectively activated electromagnet may be periodically activated and deactivated by the controller so as to cause the weight holder to reciprocally move relative to the drive saddle at a desired frequency, and amplitude, along a line of reference/work plane that passes through a center of mass of the drive assembly.

14. The vibratory conveyor as claimed in claim 1, and wherein a frequency and an amplitude of the movement of the weight holder may be altered by the controller.

15. The vibratory conveyor as claimed in claim 1, and wherein the generated reciprocal force, and the resulting reciprocal motion of the elongated conveyor bed effects movement of product along the product transporting surface of the elongated conveyor bed, and between the first and second ends of the elongated conveyor bed.

16. A vibratory conveyor, comprising:
a base having a first side, and a spaced apart, and parallel, second side, and wherein the first and second sides each have a first end, a second end, a top edge and a bottom edge, and wherein an end panel communicates between the first side, and the second sides at one end thereof, and wherein the base further defines a medial channel which is located between the first and second sides;
a drive assembly which is borne by the base, and is further carried within the medial channel, and wherein the drive assembly comprises a drive saddle, a weight holder, and a selectively energizable electromagnet, and wherein the drive saddle has a first side, and a parallel, spaced apart, second side, and wherein each side has a first end, and a second end, and wherein each side further has a laterally outwardly facing surface, and an opposing, laterally inwardly facing surface, and wherein a crossbeam structurally communicates between the first side, inwardly facing surface, and the second side, Inwardly facing surface, and wherein the crossbeam structurally carries a magnet seat between the first side, and the second side, and at a location which is generally medial between the first end and the second end, and wherein the magnet seat further defines a plurality of spaced holes for receiving mounting posts which adjustably position and carry a selectively energizable electromagnet, and wherein the first and the second sides each carry a plurality of spacedly arrayed spring arm mounts on the laterally inwardly facing surfaces, and wherein each of the plurality of spring arm mounts carries an elongated spring arm; and
the plurality of elongated spring arms movably support to the weight holder in a spaced orientation relative to the drive saddle; and wherein
the weight holder has a first side, and a spaced apart, and parallel, second side, and wherein each of the first and second sides has a first end, and a second end, and wherein a mounting block is carried between the first side, and the second side, and the mounting block carries an attractor plate, and wherein the weight holder first and second sides, each carry a plurality of spacedly arrayed spring arm mounts on a laterally outwardly facing surface thereof, and the individual elongated spring arms are mounted on each of the plurality of spacedly arrayed spring arm mounts carried by the weight holder, and to the plurality of spring arm mounts carried by the drive saddle to support the weight holder in the spaced orientation relative to the drive saddle; and wherein
the selectively energizable electromagnet mounted on the magnet seat of drive saddle, when rendered operable, sequentially, and magnetically attracts, the attractor plate which is carried by the weight holder when electrical energy is selectively supplied to the electromagnet by a controller which responsively draws the attractor plate closer to the selectively energizable magnet and correspondingly deflects/biases the multiplicity of spring arms in a first direction; and wherein
when the selectively energizable magnet is deenergized, the multiplicity of spring arms return to an unbiased position effectively moving the weight holder in a second direction opposite the first direction, and wherein the movement of the weight holder generates a force along a predetermined line of reference/work plane;
an elongated conveyor bed having opposite first and second ends, a top surface defining a product transporting surface which supports a product for movement between the respective opposite ends of the elongated conveyor bed, and a bottom surface, and wherein the elongated conveyor bed is reciprocally and resiliently supported in spaced relation relative to the base, and wherein the elongated conveyor bed has a center of mass through which the predetermined line of reference passes;
a multiplicity of elongated resilient spring legs which individually, and resiliently support the elongated conveyor bed in spaced relation relative to the base, and wherein each of the multiplicity of elongated resilient spring legs each have a respective first end which is fixedly attached to the base, and an opposite second end, which is fixedly affixed to the elongated conveyor bed; and
a controller which electrically and operationally communicates with a source of electrical power, and wherein the controller selectively supplies electric power to the selectively energizable electromagnet so as to cause the electromagnet to generate a magnetic field, and wherein when the selectively energizable electromagnet is energized by the controller the generated magnetic field draws the attractor plate into closer proximity to the energized selectively energizable electromagnet, thereby causing the weight holder to reciprocally move relative to the drive saddle at a desired frequency, and amplitude, and along the line of reference/work plane, and wherein the frequency of the weight holder movement may be adjusted by the controller, and wherein the reciprocal movement of the weight holder relative to the drive saddle generates a predetermined amount of vibratory force which is imparted to the elongated conveyor bed, so as to effect reciprocal motion of the elongated conveyor bed, and facilitate the movement of the product along the product transporting surface.

17. The vibratory conveyor as claimed in claim 1 and further comprising:
a second selectively energizable electromagnet carried by the drive saddle; and
a second attractor plate carried by the weight holder.

18. The vibratory conveyor as claimed in claim 1 and wherein the selectively energizable electromagnet is carried by the weight holder; and
the attractor plate is carried by the drive saddle.

19. A drive assembly for a vibratory conveyor comprising:
a selectively energizable electromagnet; and
an attractor plate spaced apart from the selectively energizable electromagnet by a predetermined distance; and
a plurality of spacedly arrayed elongated springs interconnecting, and communicating between a drive saddle that carries the selectively energizable electromagnet, and a weight holder that carries the attractor plate; and wherein
selective energizing of the selectively energizable electromagnet causes the selectively energizable electromagnet to generate a magnetic field which draws the attractor plate, and the weight holder, into a first direction of movement and into closer proximity to the energized selectively energizable electromagnet; and
selective deenergizing of the selectively energizable electromagnet allows the plurality of spacedly arrayed elongated springs to bias the attractor plate, and the weight holder, into a second to direction of movement and a distally from the selectively energizable electromagnet, and the second to direction of travel is opposite the first direction of travel; and
selectively energizing and deenergizing the selectively energizable magnet generates reciprocal vibration that is communicated to an elongated conveyor.

20. A vibratory conveyor, comprising:
an elongated, reciprocally movable conveyor bed for carrying a product along a path of travel, and wherein the elongated reciprocally movable conveyor bed has a center of mass;
a base for supporting the elongated reciprocally movable conveyor bed relative to a supporting surface;
a multiplicity of spacedly arrayed elongated springs extending from the base, and supporting the reciprocally movable conveyor bed in spaced, reciprocally movable relation relative to the base; and
a drive assembly carried by the base, the drive assembly having a weight holder that has an attractor plate, a total predetermined weight and a center of mass, and the drive assembly further has a selectively energizable electromagnet that is spaced apart, a predetermined distance, from the attractor plate, and wherein selective energizing and selective de-energizing of the electromagnet effects a reciprocal motion of the weight holder and attractor plate relative to the selectively energizable electromagnet so as to create a reciprocating force which extends along a predetermined line of reference/work plane which passes through the center of mass of the weight holder, and which is parallel to a line passing through the center of mass of the elongated reciprocally movable elongated conveyor bed, which affects the movement of the product along the path of travel of the conveyor bed; and
a controller that selectively energizes and selectively de-energizes the selectively energization electromagnet.
